(19) United States
(12) Patent Application Publication
(10) Pub. No.: US 2004/0014917 A1
(43) Pub. Date: Jan. 22, 2004

(54) Catalyst support, production and use thereof in the polymerization of olefins

(76) Inventors: Thomas Eberle, Darmstadt (DE); Dieter Lubda, Bensheim (DE); Katrin Kohler, Dossenheim (DE); Jens Eichhorn, Reinheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/399,992

(22) PCT Filed: Sep. 27, 2001
(86) PCT No.: PCT/EP01/11202

(51) Int. Cl. B01J 21/12; B01J 31/00; C08F 4/44

(52) U.S. Cl. 526/160; 502/235; 502/102; 502/103; 502/117; 526/901; 526/943

(57) ABSTRACT

The present invention relates to a support for catalysts which has a content of physisorbed water of at least 2.5% by weight. Further subject-matters of the application are a process for preparing heterogeneous catalysts containing these supports and the use of these catalysts for olefin polymerization and also a polymerization process using the catalysts.

The invention relates to novel supports for catalysts, a process for preparing heterogeneous catalysts containing this support and the use of these catalysts for the polymerization of olefins as well as a polymerization process using the catalysts.

Metallocene-catalysed polymerization has experienced a tremendous upswing since the beginning of the 1980s. First thought of as model systems for Ziegler-Natta catalysis, it has increasingly become an independent process with a tremendous potential for the (co)polymerization of ethene and higher 1-olefins. Reasons for the rapid development have been the activity-increasing use of the cocatalyst methylalumin-oxane in place of simple trialkyl compounds and also the steady improvement in the activity and stereo-selectivity due to the determination of systematic catalyst structure/activity relationships (G. G. Hlatky, Coord. Chem. Rev. 1999, 181, 243; R. Mülhaupt, Nachr. Chem. Tech. Lab. 1993, 41, 1341).

However, homogeneous catalysts have only limited suitability for industrial use in the gas-phase or suspension polymerizations customarily employed. Agglomeration of the catalytically active centres frequently occurs, with the consequence that cake material is formed on the reactor walls, etc., known as reactor fouling. Supported catalysts have been developed for this reason. The catalyst support is supposed to avoid the problems mentioned.

The support substances usually described are based on inorganic compounds such as silicon oxides (e.g. U.S. Pat. No. 4,808,561, U.S. Pat. No. 5,939,347, WO 96/34898) or aluminium oxides (e.g. M. Kaminaka, K. Soga, Macromol. Rapid Commun. 1991, 12, 367) or sheet silicates (e.g. U.S. Pat. No. 5,830,820; DE-A-197 27 257; EP-A-849,288), zeolites (e.g. L. K. Van Looveren, D. E. De Vos, K. A. Vercruysse, D. F. Geysen, B. Janssen, P. A. Jacobs, Cat. Lett. 1998, 56(1), 53) or on model systems such as cyclodextrins (D.-H. Lee, K.-B. Yoon, Macromol. Rapid Commun. 1994, 15, 841; D. Lee, K. Yoon, Macromol. Symp. 1995, 97, 185) or polysiloxane derivatives (K. Soga, T. Arai, B. T. Hoang, T. Uozumi, Macromol. Rapid Commun. 1995, 16, 905).

When using supports, the decrease in activity and selectivity of the catalyst compared with homogeneous polymerization arises as a new problem. In general, it is assumed that the support materials should be as dry as possible prior to reaction with the catalyst. For example, the European Patent Application EP-A-0 685 494 recommends drying of the support, which may be an aluminium, titanium, zirconium or silicon oxide, at from 110 to 800° C.

It has now surprisingly been found that a high water content on the support surface is advantageous for high loading with catalyst and thus a high activity of the catalysts.

The present invention accordingly provides, firstly, a support for catalysts which has a content of physisorbed water of at least 2.5% by weight.

The present invention further provides a process for preparing a heterogeneous catalyst suitable for the synthesis of polyolefins, in which

a) a support having a content of physisorbed water of at least 2.5% by weight is reacted with at least one organometallic compound of a (semi)metal of main group 3 or 4 of the Periodic Table and

b) with at least one compound of a transition metal of transition groups 3 to 8 of the Periodic Table to give the heterogeneous catalyst.

For the purposes of the present invention, the content of physisorbed water is the water content of the support according to the invention determined by Karl-Fischer analysis. According to the invention, the supports preferably have water contents in the range from 3 to 8% by weight.

As has been found, these high water contents are advantageous for achieving a high loading of the support with catalysts and especially cocatalysts. The uptake of the frequently used cocatalyst methyl-aluminoxane in particular is aided by a high water content of the support. The catalytic activity of the loaded support is also increased as a result.

The support according to the invention is preferably an oxidic material which is preferably selected from among the oxides of the elements of main groups 3 and 4 and transition groups 3 to 8 of the Periodic Table. It is particularly preferably an aluminium, silicon, boron, germanium, titanium, zirconium or iron oxide or a mixed oxide or an oxide mixture of the specified compounds.

In a particularly preferred variant, the support is a mixed aluminium-silicon oxide. Here, the term “aluminium-silicon oxide” encompasses both a preferably finely divided, physical mixture of silicon dioxide and aluminium oxide and also a true mixed oxide in which Si—O—Al bridges are present.

A particularly preferred support is obtainable by a process in which

a) separate gels of aluminium (hydr)oxide and silicon (hydr)oxide are prepared first,

b) the two gels are subsequently mixed with one another and homogenized,

c) the homogenized mixture is spray dried.

It has been found that these preferred supports are also particularly suitable as supports for catalysts when they do not have the water content specified according to the invention. The mixed oxides obtainable in this way and the process for preparing them are therefore also provided by the present invention, regardless of the water content.

These preferred supports are amorphous, which for the purpose of the present invention means X-ray amorphous, i.e. the X-ray diffraction pattern of the supports according to the invention does not display sharp peaks but only the very broad reflection referred to as “amorphous halo”.

Detailed examination of the supports using, inter alia, energy-dispersive X-ray spectroscopy (EDX) shows that aluminium and silicon are homogeneously distributed in the support particles. No domains in which only SiO₂ or only Al₂O₃ is present, as would be expected in the case of a material produced by simple mixing of the oxides, are observed.

Without being tied to this theory, it is presumed that this particular structure is important for a further advantage of the supports preferred according to the invention. The particles of the support material according to the invention allow it to be loaded with catalyst by customary methods, with the particle size increasing slightly due to the catalyst applied to the surface but the particle shape being substantially retained.

The particularly uniform distribution of aluminium and silicon in the support material also enables a particularly uniform loading with the catalyst to be achieved. This allows a largely morphology-controllable polymerization; the particle shape of the polymer particles can be influenced by appropriate selection of the shape of the support particles.

Due to the particular nature of the particles obtainable by means of the preparative process described., the support material particles break up during the polymerization and thus make available the catalyst centres bound to their internal surface, which leads to an increase in the catalyst activity compared with stable support particles. A further advantage of the breaking-up of the particles is that only tiny support particles encased in polymer are present in the resulting polymer and do not significantly affect the physical and chemical properties of the polymer relevant to its use.

In these supports, a particularly uniform distribution of aluminium and silicon is achieved by the homogenization and, in addition, a particularly fragile structure is obtained as a result of the rapid spray drying which is associated with a shrinkage of the particles by a factor of about 3. As already discussed above, the parameters have a positive effect during the polymerization.

This preferred catalyst support is produced in a multistage process. In this process, the two silicon and aluminium components are firstly prepared by separate routes: aluminium (hydr)oxide is obtained, for example, by alkaline precipitation from aluminium salts, for example from aluminium sulphate, acetate or oxalate. However, the direct use of commercially obtainable aluminium hydroxides is also possible.

Silicon (hydr)oxide can be obtained by comparable procedures from silicic acid or hydrolysable molecular precursors such as silicon tetrachloride or orthosalicic esters of lower alcohols, preferably tetraethoxysilane. The two (hydr)oxides obtained as gels are, after setting the desired silicon/aluminium ratio, homogenized and subsequently spray dried. The amorphous structural units are retained in the spray drying process. The material can subsequently be washed free of salts and classified.

For the purpose of the present invention, the expression aluminium or silicon (hydr)oxide refers to intermediates which have a polymeric structure but are still distinctly different from the 3-dimensional network structure of the oxides and have a significantly higher reactivity than the oxides due to the higher proportion of hydroxy groups.

The ratios of SiO₂ to Al₂O₃ in the support are usually in the range from 100:1 to 1:2, preferably greater than 1:1 and particularly preferably greater than 2:1. For simultaneous optimization of hydroxy group density (active surface area) and surface area present (determined by the BET method), it can be particularly advantageous to set a ratio of SiO₂ to Al₂O₃ in the range from 20:1 to 5:1.

In a preferred embodiment of the invention, spherical particles are obtained. Here, spherical means that the particles look like spheres in scanning electron micrographs. “Spherical” can be quantified in terms of the means of the 3 mutually perpendicular diameters of the particles differing by a maximum of 50% of the length, i.e. all ratios of the three mutually perpendicular diameters are in the range from 1.5:1 to 1:1.5. The ratios of the 3 mean diameters are preferably all in the range from 1.3:1 to 1:1.3, i.e. the diameters differ from one another by a maximum of 30%.

The support material of the invention usually has mean particle sizes in the range from 1 to 100 μm, preferably in the range from 3 to 50 μm. The particle size distribution can be controlled by means of a classification step, for example by air classification. The surface area of the particles, determined by the BET method (S. Brunnauer, P. H. Emmett, E. Teller, J. Am. Chem. Soc. 1938, 60, 309), is usually in the range from 50 to 500 mm²/g with surface areas in the range from 150 to 450 m²/g being preferred. The pore volume, likewise measured by the BET method, is typically in the range from 0.5 to 4.5 ml/g, preferably above 0.8 ml/g and particularly preferably in the range from 1.5 to 4.0 ml/g.

The pH of the support material of the invention is preferably less than or equal to 7.

The supports according to the invention are suitable as supports for a variety of catalysts. In principle, all homogeneous catalysts can be immobilized with the aid of these supports.

In a particularly important embodiment of the present invention, the supports are used as supports for catalysts for olefin polymerization.

Customary catalyst systems for the polymerization of olefins comprise a compound of a transition metal of transition groups 3 to 8 of the Periodic Table and a cocatalyst which is usually an organometallic compound of a (semi)metal of main group 3 or 4 of the Periodic Table.

The present invention therefore also provides a heterogeneous catalyst comprising at least one support as described above, at least one compound of a transition metal of transition groups 3 to 8 of the Periodic Table and at least one organometallic compound of a (semi)metal of main group 3 or 4 of the Periodic Table, where the two metal compounds are absorbed on the support and together form the catalytically active species.

The compound of a transition metal of transition groups 3 to 8 of the Periodic Table, hereinafter also referred to as “catalyst”, is preferably a complex, particularly preferably a metallocene compound. This can in principle be any metallocene. Conceivable metallocenes are bridged (ansa-) and unbridged metallocene complexes having (substituted) π ligands such as cyclopentadienyl, indenyl or fluorenyl ligands. Symmetrical or unsymmetrical complexes with central metals from groups 3 to 8 are possible. As central metal, preference is given to using the elements titanium, zirconium, hafnium, vanadium, palladium, nickel, cobalt, iron and chromium, with particular preference being given to titanium and especially zirconium.

Examples of suitable zirconium compounds are:

bis(cyclopentadienyl)zirconium monochloride monohydride,

bis(cyclopentadienyl)zirconium monobromide monohydride,

bis(cyclopentadienyI)methylzirconium hydride,

bis(cyclopentadienyl)ethylzirconium hydride,

bis(cyclopentadienyl)cyqlohexylzirconium hydride,

bis(cyclopentadienyl)phenylzirconium hydride,

bis(cyclopentadienyl)benzylzirconium hydride,

bis(cyclopentadienyl)neopentylzirconium hydride,

bis(methylcyclopentadienyl)zirconium monochloride monohydride,

bis(indenyl)zirconium monochloride monohydride,

bis(cyclopentadienyl)zirconium dichloride,

bis(cyclopentadienyl)zirconium dibromide,

bis(cyclopentadienyl)methylzirconium monochloride,

bis(cyclopentadienyl)ethylzirconium monochloride,

bis(cyclopentadienyl)cyclohexylzironium monochloride,

bis(cyclopentadienyl)phenylzirconium monochloride,

bis(cyclopentadienyl)benzylzirconium monochloride,

bis(methylcyclopentadienyl)zirconium dichloride,

bis(1,3-dimethylcyclopentadienly)zirconium dichloride,

bis(n-butylcyclopentadienyl)zirconium dichloride,

bis(n-propylcyclopentadienyl)zirconium dichloride,

bis(isobutylcyclopentadienyl)zirconium dichloride,

bis(cyclopentylcyclopentadienyl)zirconium dichloride,

bis(octadecylcyclopentadienyl)zirconium dichloride,

bis(indenyl)zirconium dichloride,

bis(indenyl)zirconium dibromide,

Bis(indenyl)dimethylzirconium,

bis(4,5,6,7-tetrahydro-1-indenyl)dimethylzirconium,

bis(cyclopentadienyl)diphenylzirconium,

bis(cyclopentadienyl)dibenzylzirconium,

bis(cyclopentadienyl)methoxyzirconium chloride,

bis(cyclopentadienyl)ethoxyzirconium chloride,

bis(cyclopentadienyl)butoxyzirconium chloride,

bis(cyclopentadienyl) (2-ethylhexoxy)zirconium chloride,

bis(cyclopentadienyl)methylzirconium ethoxide,

bis(cyclopentadienyl)methylzirconium butoxide,

bis(cyclopentadienyl)ethylzirconium ethoxide,

bis(cyclopentadienyl)phenylzirconium ethoxide,

bis(cyclopentadienyl)benzylzirconium ethoxide,

bis(methycyclopentadienyl)benzylzirconium ethoxide,

bis(idenyl)ethoxyzirconium chloride,

bis(cyclopentadienyl)ethoxyzirconium,

bis(cyclopentadienyl)butoxyzirconium,

bis(cyclopentadienyl) (2-ethylhexoxy)zirconium,

bis(cyclopentadienyl)phenoxyzirconium monochloride,

bis(cyclopentadienyl)cyclohexoxyzirconium chloride,

bis(cyclopentadienyl)phenylmethoxyzirconium chloride,

bis(cyclopentadienyl)methylzirconium phenylmethoxide,

bis(cyclopentadienyl)trimethylsiloxyzirconium chloride,

bis(cyclopentadienyl)triphenylsiloxyzirconium chloride,

bis(cyclopentadienyl)thiophenylzirconium chloride,

bis(cyclopentadienyl)neoethylzirconium chloride,

bis(cyclopentadienyl)bis(dimethylamide)zirconium,

bis(cyclopentadienyl)dimethylamidezirconium chloride,

dimethylsilylenebis(4,5,6,7-tetrahydro-1-indenyl)zirconium dichloride,

dimethylsilylenebis(4,5,6,7-tetrahydro-1-indenyl)dimethyl-zirconium,

dimethylsilylenebis(2-methyl-4,5-benzoindenyl)zirconium dichloride,

dimethylsilylenebis(4-tert-butyl-2-methylcyclopentadienyl)zirconium dichloride,

dimethylenesilylbis(4-tert-butyl-2-methylcyclopentadienyl)dimethylzirconium,

ethylenebis(indenyl)ethoxyzirconium chloride,

ethylenebis(4,5,6,7-tetrahydro-1-indenyl)ethoxyzirconium chloride,

ethylenebis(indenyl)dimethylzirconium,

ethylenebis(indenyl)diethylzirconium,

ethylenebis(indenyl)diphenylzirconium,

ethylenebis(indenyl)dibenzylzirconium,

ethylenebis(indenyl)methylzirconium monobromide,

ethylenebis(indenyl)ethylzirconium monochloride,

ethylenebis(indenyl)benzylzirconium monochloride,

ethylenebis(indenyl)methylzirconium monochloride,

ethylenebis(indenyl)zirconium dichloride,

ethylenebis(indenyl)zirconium dibromide,

ethylenebis(4,5,6,7-tetrahydro-1-indenyl)dimethyl-zirconium,

ethylenebis(4,5,6,7-tetrahydro-1-indenyl)methylzirconium monochloride,

ethylenebis(4,5,6,7-tetrahydro-1-indenyl)zirconium dichloride,

ethylenebis(4,5,6,7-tetrahydro-1-indenyl)zirconium dibromide,

ethylenebis(4-methyl-1-indenyl)zirconium dichloride,

ethylenebis(5-methyl-1-indenyl)zirconium dichloride,

ethylenebis(6-methyl-1-indenyl)zirconium dichloride,

ethylenebis(7-methyl-1-indenyl)zirconium dichloride,

ethylenebis(5-methoxy-1-indenyl)zirconium dichloride,

ethylenebis(2,3-dimethyl-1-indenyl)zirconium dichloride,

ethylenebis(4,7-dimethyl-1-indenyl)zirconium dichloride,

ethylenebis(4,7-dimethoxy-1-indenyl)zirconium dichloride,

ethylenebis(indenyl)zirconium dimethoxide,

ethylenebis(indenyl)zirconium diethoxide,

ethylenebis(indenyl)methoxyzirconium chloride,

ethylenebis(indenyl)ethoxyzirconium chloride,

ethylenebis(indenyl)methylzirconium ethoxide,

ethylenebis(4,5,6,7-tetrahydro-1-indenyl)zirconium dimethoxide,

ethylenebis(4,5,6,7-tetrahydro-1-indenyl)zirconium diethoxide,

ethylenebis(4,5,6,7-tetrahydro-1-indenyl)methoxyzirconium chloride,

ethylenebis(4,5,6,7-tetrahydro-1-indenyl)ethoxyzirconium chloride,

ethylenebis(4,5,6,7-tetrahydro-1-indenyl)methylzirconium ethoxide,

ethylenebis(4,5,6,7-tetrahydro-1-indenyl)dimethyl-zirconium,

isopropylene(cyclopentadienyl)(1-fluorenyl)-zirconium dichloride,

diphenylmethylene(cyclopentadienyl)(1-fluorenyl)zirconium dichloride.

Examples of suitable titanium compounds are:

bis(cyclopentadienyl)titanium monochloride monohydride,

bis(cyclopentadienyl)methyltitanium hydride,

bis(cyclopentadienyl)phenyltitanium chloride,

bis(cyclopentadienyl)benzyltitanium chloride,

bis(cyclopentadienyl)titanium dichloride,

bis(cyclopentadienyl)dibenzyltitanium,

bis(cyclopentadienyl)ethoxytitanium chloride,

bis(cyclopentadienyl)butoxytitanium chloride,

bis(cyclopentadienyl)methyltitanium ethoxide,

bis(cyclopentadienyl)phenoxytitanium chloride,

bis(cyclopentadienyl)trimethylsiloxytitanium chloride,

bis(cyclopentadienyl)thiophenyltitanium chloride,

bis(cyclopentadienyl)bis(dimethylamide)titanium,

bis(cyclopentadienyl)ethoxytitanium,

bis(n-butylcyclopentadienyl)titanium dichloride,

bis(cyclopentylcyclopentadienyl)titanium dichloride,

bis(indenyl)titanium dichloride,

ethylenebis(indenyl)titanium dichloride,

ethylenebis(4,5,6,7-tetrahydro-1-indenyl)titanium dichloride and

dimethylsilylene(tetramethylcyclopentadienyl)(tert-butylamide)titanium dichloride,

Examples of suitable hafnium compounds are:

bis(cyclopentadienyl)hafnium monochloride monohydride,

bis(cyclopentadienyl)ethylhafnium hydride,

bis(cyclopentadienyl)phenylhafnium chloride,

bis(cyclopentadienyl)hafnium dichloride,

bis(cyclopentadienyl)benzylhafnium,

bis(cyclopentadienyl)ethoxyhafnium chloride,

bis(cyclopentadienyl)butoxyhafnium chloride,

bis(cyclopentadienyl)methylhafnium ethoxide,

bis(cyclopentadienyl)phenoxyhafnium chloride,

bis(cyclopentadienyl)thiophenylhafnium chloride,

bis(cyclopentadienyl)bis(diethylamide)hafnium,

ethylenebis(indenyl)hafnium dichloride,

ethylenebis(4,5,6,7-tetrahydro-1-indenyl)hafnium dichloride and

dimethylsilylenebis(4,5,6,7-tetrahydro-1-indenyl)hafnium dichloride.

Examples of suitable iron compounds are:

2,6-[1-(2,6-diisopropylphenylimino)ethyl]pyridineiron dichloride,

2,6-[1-(2,6-dimethylphenylimino)ethyl]pyridineiron dichloride.

Examples of suitable nickel compounds are:

(2,3-bis(2,6-diisopropylphenylimino)butane)nickel dibromide,

1,4-bis(2,6-diisopropylphenyl)acenaphthenediiminenickel dichloride,

1,4-bis(2,6-diisopropylphenyl)acenaphthenediiminenickel dibromide.

Examples of suitable palladium compounds are:

(2,3-bis(2,6-diisopropylphenylimino)butane)palladium dichloride and

(2,3-bis(2,6-diisopropylphenylimino)butane)dimethyl-palladium.

Particular preference is given to using zirconium compounds, especially the compounds bis(cyclopentadienyl)zirconium dichloride, bis(n-butylcyclopentadienyl)zirconium dichloride, ethylenebis(4,5,6,7-tetrahydro-1-indenyl) zirconium dichloride, bis (methylcyclopentadienyl)zirconium dichloride and bis-(1,3-dimethylcyclopentadienyl)zirconium dichloride.

However, the compound of a transition metal of transition groups 3 to 8 can, according to the invention, also be a classical Ziegler-Natta compound such as titanium tetrachloride, tetraalkoxytitanium, alkoxytitanium chlorides, vanadium halides, vanadium oxide halides and alkoxyvanadium compounds in which the alkyl radicals have from 1 to 20 carbon atoms.

According to the invention, it is possible to use either pure transition metal compounds or mixtures of various transition metal compounds. In the latter case, either mixtures of metallocenes among one another or Ziegler-Natta compounds among one another or else mixtures of metallocenes with Ziegler-Natta compounds may be advantageous.

The organometallic compound of a (semi)metal of main group 3 or 4 of the Periodic Table, hereinafter also referred to as “cocatalyst”, is preferably a compound of one of the elements boron, aluminium, tin or silicon, preferably a compound of boron or aluminium. Halide-free compounds are preferred. The organic radicals of the compounds are preferably selected from the group consisting of alkyl, alkenyl, aryl, alkaryl, aralkyl, alkoxy, aryloxy, alkaryloxy and aralkoxy and fluorine-substituted derivatives.

Preferred compounds are trialkylaluminium compounds, e.g. trimethylaluminium, triethylaluminium, tripropylaluminium and triisopropylaluminium.

Particular preference is also given to aluminoxanes having alkyl groups on the aluminium, e.g. methylaluminoxane ethylaluminoxane, propylaluminoxane, isobutylaluminoxane, phenylaluminoxane or benzylaluminoxane. Very particular preference is given to methylaluminoxane, which is frequently referred to as MAO for short.

The mean particle size of the catalyst particles is usually in the range from 1 to 150 μm, preferably in the range from 3 to 75 μm.

In a preferred embodiment of the invention, the heterogeneous catalyst prepared according to the invention allows the preparation of polymer particles having a controllable particle size and shape. The particle size can be adjusted within the range from about 50 μm to about 3 mm. A preferred particle shape is the spherical shape which, as described above, can be produced by means of spherical support particles having a particularly uniform catalyst loading.

The present invention further provides a process for preparing the novel heterogeneous catalyst suitable for the synthesis of polyolefins, in which

a) a support as described above is reacted with at least one organometallic compound of a (semi)metal of main group 3 or 4 of the Periodic Table and

b) with at least one compound of a transition metal of transition groups 3 to 8 of the Periodic Table to give the heterogeneous catalyst.

The preparation of the heterogeneous catalysts using the support according to the invention can be carried out by various methods, taking particular account of the order of the reaction of the components with one another:

In a preferred process., the cocatalyst is firstly absorbed on the support, after which the catalyst is added. In another likewise preferred process, a mixture of catalyst and cocatalyst is absorbed on the support. In particular cases, it may also be preferred to immobilize the catalyst on the support first and subsequently to react the product with the cocatalyst. Alternatively, for example, the cocatalyst methyl-aluminoxane can also be generated in situ by reaction of trimethylaluminium with a water-containing support material.

The direct chemical bonding of the metallocene catalyst on the support with the aid of a spacer or anchor group is also a possible step in the preparation of the heterogeneous catalyst.

In the preparation of the catalysts of the invention, it is important that the support used in the reaction with the transition metal compound or the organometallic compound has the water content specified according to the invention. For this reason, no further drying of the spray-dried support takes place in a preferred process according to the invention for preparing the catalyst.

However, it may also be preferred to dry the support according to the invention prior to reaction with catalyst or cocatalyst. If drying is carried out, it takes place at temperatures below 400° C., preferably below 250° C. and particularly preferably at not more than 180° C.

It is usual to suspend the support in an inert solvent and to add catalyst and cocatalyst as solution or suspension. After the individual reaction steps, the intermediate/product can be washed with a suitable solvent for the purposes of purification.

All process steps in the preparation of the catalyst are preferably carried out under protective gas, for example argon or nitrogen.

Examples of suitable inert solvents are pentane, isopentane, hexane, heptane, octane, nonane, cyclopentane, cyclohexane, benzene, toluene, xylene, ethylbenzene and diethylbenzene.

In a particularly preferred variant of the process of the invention, the support is reacted with an aluminoxane, preferably commercial methylaluminoxane. Here, the oxidic support is suspended in, for example, toluene and subsequently reacted at temperatures of from 0 to 140° C. with the aluminium component for about 30 minutes. After washing a number of times, the immobilized methylaluminoxane is obtained. The supported cocatalyst is subsequently brought into contact with a metallocene, preferably dicyclopenta-dienylzirconium dichloride, in a catalyst/cocatalyst ratio of from 1:1 to 1:100 000. The mixing time is from 5 minutes to 48 hours, preferably from 5 to 60 minutes.

The actual catalytically active centre of the heterogeneous catalyst of the invention is only formed in the reaction of the support with the components catalyst and cocatalyst.

According to the invention, preference is given to using the heterogeneous catalysts for the preparation of polyolefins.

Accordingly, the present invention also provides for the use of a heterogeneous catalyst as described above for the preparation of polyolefins.

For the purposes of the present invention, polyolefins are, in completely general terms, macromolecular compounds which can be obtained by polymerization of substituted or unsubstituted hydrocarbon compounds having at least one double bond in the momoner molecule.

Olefin monomers preferably have a structure corresponding to the formula R¹CH═CHR², where R¹ and R² may be identical or different and are selected from the group consisting of hydrogen and cyclic and acyclic alkyl, aryl and alkylaryl radicals having from 1 to 20 carbon atoms.

Olefins which can be used are monoolefins, for example ethylene, propylene, 1-butene, 1-pentene, 1-hexene, 1-octene, 1-hexadecene, 1-octadecene, 3-methyl-1-butene, 4-methyl-1-pentene, 4-methyl-1-hexene, diolefins such as 1,3-butadiene, 1,4-hexadiene, 1,5-hexadiene, 1,6-hexadiene, 1,6-octadiene, 1,4-dodecadiene, aromatic olefins such as styrene, o-methylstyrene, m-methylstyrene, p-methylstyrene, p-tert-butylstyrene, m-chlorostyrene, p-chlorostyrene, indene, vinylanthracene, vinylpyrene, 4-vinylbiphenyl, dimethanooctahydronaphthalene, acenaphthalene, vinylfluorene, vinylchrysene, cyclic olefins and diolefins, for example cyclopentene, 3-vinylcyclohexene, dicyclopentadiene, norbornene, 5-vinyl-2-norbornene, tertethylidene-2-norbornene, 7-octenyl-9-borabicyclo-[3.3. 1]nonane, 4-vinylbenzocyclobutane, tetracyclododecene and also, for example, acrylic acid, methacrylic acid, methyl methacrylate, ethyl acrylate, acrylonitrile, 2-ethylhexyl acrylate, methacrylonitrile, maleimide, N-phenylmaleimide, vinylsilane, trimethylallylsilane, vinyl chloride, vinylidene chloride, isobutylene.

Particular preference is given to the olefins ethylene, propylene and further 1-olefins in general, which are either homopolymerized or copolymerized in mixtures with other monomers.

Accordingly, the present invention further provides a process for preparing polyolefins in which—a heterogeneous catalyst as described above and an olefin of the formula R¹CH═CHR, where R¹ and R² may be identical or different and are selected from the group consisting of hydrogen and cyclic and acyclic alkyl, aryl and alkylaryl radicals having from 1 to 20 carbon atoms, are used.

The polymerization is carried out in a known manner by solution, suspension or gas-phase polymerization, continuously or batchwise, with gas-phase and suspension polymerization being expressly preferred. Typical temperatures in the polymerization are in the range from 0° C. to 200° C., preferably in the range from 20° C. to 140° C.

The polymerization preferably takes place in an autoclave. If necessary, hydrogen can be added as molar mass regulator during the polymerization.

The heterogeneous catalysts used according to the invention make it possible to prepare homopolymers, copolymers and block copolymers.

As described above, virtually spherical polymer particles with a controllable particle size can be obtained by appropriate selection of the support.

The invention therefore also provides for the use of a heterogeneous catalyst according to the invention or a heterogeneous catalyst prepared according to the invention for preparing polyolefins having a spherical particle structure.

### EXAMPLES

### Example 1

Production of the Support:

a) Preparation of Aluminium Hydroxide

14.5 kg of aluminium sulphate were dissolved in 45 l of water and, after mixing well, quickly added to a 15% ammonia solution at a temperature of 40° C. The precipitated aluminium hydroxide was aged by refluxing for 48 hours and was then allowed to cool. The aluminium hydroxide gel was freed of the major part of the remaining ammonia by decanting off the supernatant liquid four times. The gel was subsequently diluted to an aluminium hydroxide content of about 2% by mixing with water and was made available.

b) Preparation of Silicon Hydroxide (Polysalicic Acid)

300 l of water were placed in a stirred reactor and, while stirring continually, a mixture of 35 kg of water with 4 kg of concentrated sulphuric acid and 30 kg of water and 31 kg of water glass were added simultaneously in such a way that the mixture in the reaction vessel was maintained at a pH of 5. After addition of the reactants, the mixture was maintained at 90° C. for 5 hours without stirring. The resulting silicon hydroxide gel contained about 2% of solids.

c) Preparation of the Mixed Oxide (SiO₂/Al₂O₃ Ratio=9:1)

To produce the mixed oxide, 90 kg of the 2% silicon hydroxide gel (from b)) and 10 kg of the aluminium hydroxide gel (from a)) were mixed well by stirring for one hour and comminuted by means of a homogenizer (Lab 60, from APV Schroder) at about 300 bar. The freshly homogenized mixture was spray dried in a spray dryer (Niro C2, from Niro) and the resulting particles were collected in a cyclone. The material is washed free of salts and dried. Air classification (Alpine 100MZR, from Alpine) gave a material having a narrow particle size distribution.

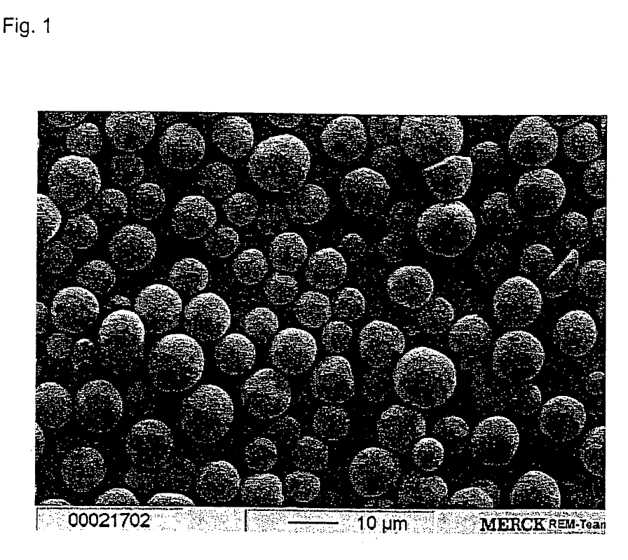

Mixed oxides having SiO₂/Al₂O₃ ratios of 7:3 and 1:1 were produced in an analogous way. The important physical and chemical properties of the supports are summarized in Table 1; FIG. 1 shows a scanning electron micrograph of the particles.

TABLE 1
Physical and chemical properties of the
supports:

| | | | |
|---|---|---|---|
| SiO₂/Al₂O₃ ratio | 9:1 | 7:3 | 1:1 |
| Surface area [m²/g] | 351 | 336 | 334 |
| Pore volume [ml/g] | 1.07 | 0.77 | 0.68 |
| Mean particle size [μm] | 10 | 10 | 10 |
| pH | 5.75 | 6.55 | 6.82 |

The particle size determination was carried out by laser light scattering using a Mastersizer 2000 from Malvern Instruments.

Surface area and pore volume were determined by the BET method using an ASAP 2400 instrument from Micrometics. Scanning electron micrographs were obtained on a Leo 1530 Gemini.

The pH of the support was determined on a 10% aqueous suspension using a laboratory pH meter 766 from Knick.

### Example 2

### Drying of the Support Material

The support material having an SiO₂/Al₂O₃ ratio of 9/1 produced as described in Example 1 was pretreated thermally as shown in Table 2. After the sample had been cooled under reduced pressure, water content and OH group density were determined.

The water content determination was carried out by the Karl Fischer method on a Mettler DL18 instrument using commercial Karl Fischer solvent, pyridine-free (Karl Fischer reagent S, from Merck) and titrant (Karl Fischer solution titrant U, from Merck). The determination of OH groups in the support material was carried out by thermogravimetric analysis/-differential thermal analysis (TGA/DTA). The TGA and DTA determinations were carried out on a thermobalance model L 81 from Linseis, Selb. To calibrae the instrument, equal amounts of Al₂O₃ were weighed out into two platinum crucibles and heated twice to 1 000° C. The heating rate was 10 K per minute, and heating was carried out in an air atmosphere. Depending on the density of the material, 30-110 mg were weighed out for the analyses, so that the crucible was completely filled.

The concentration of OH groups present on the surface was determined from the mass loss in the temperature range 200-1 000° C. To calculate the OH group density [μmol/g], the percentages by mass were converted into molar amounts (Equation (1)). The OH group density on the support can be determined according to Equation (2) when the surface area in mol/m² is known:

$$\begin{matrix}n ( support - OH ) [ µmol ] = \frac{2 \cdot m ( {H}_{2} O ) [ g ] \cdot {10}^{6}}{18.015 [ g \text{/} mol ]} & Equation ( 1 ) \\ {α}_{OH} [ µmol / {m}^{2} ] = \frac{n ( support - OH ) [ µmol ]}{( {a}_{s} ( BET ) [ {m}^{2} \text{/} g ] \cdot m ( support ) [ g ] )} & Equation ( 2 )\end{matrix}$$

TABLE 2
Thermal treatment of the support

| | Thermal | Surface | Pore | Water | OH group |
|---|---|---|---|---|---|
| | pretreatment | area | volume | content | density |
| Ex. | [° C.] | [m²/g] | [ml/g] | [% by wt.] | [mmol/g] |
| 2a | — | 351 | 1.1 | 4.3 | 4.5 |
| 2b | 200 | 356 | 1.1 | 1.0 | 4.4 |
| 2c | 400 | 367 | 1.1 | 0.9 | 3.2 |
| | 600 | not | not | | |
| 2d | | deter- | deter- | 0.8 | 1.5 |
| | | mined | mined | | |
| 2e | 800 | 355 | 1.1 | 0.8 | 0.5 |

As the pretreatment temperature increases, the OH group density and also, in particular, the content of physisorbed water decreases. Surface area and pore volume as determined by means of BET analysis remain virtually unchanged.

### Example 3

### Preparation of the Supported Catalyst

0.50 g of the support from Example 2a-2e was suspended in 35 ml of dry toluene under argon in a 100 ml three-necked flask and admixed with 3.25 ml of a 10% solution of methylaluminoxane (MAO) in toluene (5.4 mmol), and the mixture was stirred for 0.30 minutes. After the precipitate had settled, the mixture was filtered and the solid was washed twice with 5 ml each time of toluene.

The loading of the catalyst with MAO was subsequently determined (Table 3). The loading correlates both with the content of physisorbed water and with the OH group density.

The solid obtained was taken up in 35 ml of toluene and transferred to a 100 ml Buchi pressure reactor, after which 5 ml of a 0.855×10⁻³ molar Cp₂ZrCl₂ solution (4.3 μmol) were added and the mixture was stirred for 10 minutes.

### Example 4

### Polymerization

The catalyst suspension from Example 3a-3e was saturated with 2.5 bar of ethene (purity grade 4.5; from Messer Griesheim) in a 100 ml Buchi autoclave and stirred at room temperature (27.5° C.) for 1 hour. The polymerization was stopped by addition of 40 ml of acidified methanol solution. The solid was subsequently washed for a number of hours. After separating off the polymer, it was dried to constant mass under reduced pressure.

The catalyst activities found are shown in Table 3. Molecular weight and melting point were determined on the polymer particles obtained using the catalyst from Example 3a. A high molecular weight polyethene (M_{W}=523 000 g/mol, Mₙ=241 000 g/mol, M_{W}/Mₙ=2.2) having a melting point of T_{M}=138° C. was obtained.

The molecular weights of the polyolefins were determined by means of gel permeation chromatography under the conditions customary for polyolefins (135° C., 1,2,4-trichlorobenzene) as a triplicate determination on a high temperature apparatus from Knauer (separation columns: polystyrene gel 500, 10⁴, 10⁵, 10⁶ Å; flow: 1 ml/min, concentration: about 0.5-1 mg/ml; sample volume: 400 μl). The determination of the melting points of the polymers was carried out on a DSC-821 from Mettler Toledo.

TABLE 3
Properties of the catalysts

| | | | Loading with | Polymerization |
|---|---|---|---|---|
| | Water | OH group | MAO cocatalyst | activity |
| | content | density | [mol/g of | [kg_{PE}/(barₑₜₕₑₙₑ |
| Ex. | [% by wt.] | d[mmol/g] | support] | mol_{cat.} · h)] |
| 3a | 4.3 | 4.7 | 10.7 | 276 |
| 3b | 1.0 | 4.4 | 6.4 | 202 |
| 3c | 0.9 | 3.2 | 3.8 | 90 |
| 3d | 0.8 | 1.5 | 2.4 | 126 |
| 3e | 0.8 | 0.5 | 0.4 | 54 |

The loading of the support with the aluminium-containing compound MAO was measured by means of a difference determination. The Al content of the filtrate (washings from the unimmobilized MAO) was determined by means of absorption spectrometry and subsequently substracted from the initial amount of aluminium in the MAO originally used. The aluminium determinations were carried out by means of absorption spectrometry using a Varian Spectra AA800 spectrometer. For this purpose, the samples were first digested with 5 ml of sulphuric acid, 0.5 ml of hydrofluoric acid and about 0.5 ml of hydrogen peroxide and made up to 25 ml with high-purity water. Electrothermal atomic absorption spectrometry (graphite furnace) was used for the determination.

1. Support for catalysts, characterized in that it has a content of physisorbed water of at least 2.5% by weight.

2. Support for catalysts according to claim 1, characterized in that it has a water content in the range from 3 to 8% by weight and is an oxidic material which is preferably selected from among the oxides of the elements of main groups 3 and 4 and transition groups 3 to 8 of the Periodic Table and is particularly preferably an aluminium, silicon, boron, germanium, titanium, zirconium or iron oxide or a mixed oxide or an oxide mixture of the specified compounds.

3. Support for catalysts according to claim 1 or 2, characterized in that it is a mixed aluminium-silicon oxide which is preferably obtainable by a process in which
a) separate gels of aluminium (hydr)oxide and silicon (hydr)oxide are prepared first,
b) the two gels are subsequently mixed with one another and homogenized,
c) the homogenized mixture is spray dried.

4. Support according to at least one of claims 1 to 3, characterized in that the support has a particle surface area, determined by the BET method, in the range from 50 to 500 m²/g, preferably in the range from 150 to 450 m²/g, and a pore volume, likewise measured by the BET method, in the range from 0.5 to 4.5 ml/g, preferably above 0.8 ml/g and particularly preferably in the range from 1.5 to 4.0 ml/g, and the ratio of SiO₂ to Al₂O₃ is in the range from 100:1 to 1:2, preferably in the range from 20:1 to 5:1.

5. Support according to at least one of claims 1 to 4, characterized in that it consists of spherical particles in which all ratios of the means of the three mutually perpendicular diameters are in the range from 1.5:1 to 1:1.5 and the mean particle size of the catalyst particles is in the range from 1 to 100 μm, preferably in the range from 3 to 50 μm.

6. Heterogeneous catalyst suitable for the synthesis of polyolefins, comprising
a) at least one support according to at least one of claims 1 to 5,
b) at least one compound of a transition metal of transition groups 3 to 8 of the Periodic Table and
c) at least one organometallic compound of a (semi)metal of main group 3 or 4 of the Periodic Table,
where the components b) and c) are absorbed on the support a) and together form the catalytically active species.

7. Heterogeneous catalyst according to claim 6, characterized in that the compound of a transition metal of transition groups 3 to 8 of the Periodic Table is a complex, particularly preferably a metallocene compound, where the central metal is preferably selected from among the elements titanium, zirconium, hafnium, vanadium, palladium, nickel, cobalt, iron and chromium, with titanium and especially zirconium being particularly preferred central atoms, and the organometallic compound of a (semi)metal of main group 3 or 4 of the Periodic Table is a compound of one of the elements boron, aluminium, tin or silicon, preferably a compound of boron or aluminium, particularly preferably an aluminoxane, in particular methylaluminoxane.

8. Heterogeneous catalyst according to claim 6 or 7, characterized in that it consists of particles having a mean particle size in the range from 1 to 150 μm, preferably in the range from 3 to 75 μm.

9. Process for preparing a heterogeneous catalyst suitable for the synthesis of polyolefins, characterized in that
a) a support according to at least one of claims 1 to 5 is reacted with at least one organometallic compound of a (semi)metal of main group 3 or 4 of the Periodic Table and
b) with at least one compound of a transition metal of transition groups 3 to 8 of the Periodic Table to give the heterogeneous catalyst.

10. Process according to claim 9, characterized in that the cocatalyst is absorbed on the support first and the catalyst is subsequently added.

11. Process according to claim 9, characterized in that a mixture of catalyst and cocatalyst is absorbed on the support.

12. Process according to at least one of claims 9 to 11, characterized in that the compound of a transition metal of transition groups 3 to 8 of the Periodic Table which is used is a complex, particularly preferably a metallocene compound, where the central metal is preferably selected from among the elements titanium, zirconium, hafnium, vanadium, palladium, nickel, cobalt, iron and chromium, with titanium and especially zirconium being particularly preferred central atoms, and the organometallic compound of a (semi)metal of main group 3 or 4 of the Periodic Table which is used is a compound of one of the elements boron, aluminium, tin or silicon, preferably a compound of boron or aluminium, particularly preferably an aluminoxane, in particular methylaluminoxane.

13. Process according to at least one of claims 9 to 12, characterized in that either no further drying of the support apart from the spray drying takes place prior to the reaction of the support with the (co)catalyst or the drying is carried out at temperatures below 400° C., preferably below 250° C. and particularly preferably at not more than 180° C.

14. Process for producing a support for catalysts, characterized in that
a) separate gels of aluminium (hydr)oxide and silicon (hydr)oxide are prepared first,
b) the two gels are subsequently mixed with one another and homogenized,
c) the homogenized mixture is spray dried.

15. Use of a heterogeneous catalyst according to at least one of claims 6 to 8 or a heterogeneous catalyst prepared by a process according to any of claims 9 to 13 for the preparation of polyolefins.

16. Process for preparing polyolefins, characterized in that a heterogeneous catalyst according to at least one of claims 6 to 8 or a heterogeneous catalyst prepared by a process according to any of claims 9 to 13 and an olefin of the formula R¹CH═CHR², where R¹ and R² may be identical or different and are selected from the group consisting of hydrogen and cyclic and acyclic alkyl radicals having from 1 to 20 carbon atoms, are used.

17. Process for preparing polyolefins according to claim 16, characterized in that the polymerization is carried out as a gas-phase or suspension polymerization.

18. Use of a heterogeneous catalyst according to at least one of claims 6 to 8 or a heterogeneous catalyst prepared by a process according to any of claims 9 to 13 for preparing polyolefins having a spherical particle structure.
